(19) United States
(12) Patent Application Publication
(10) Pub. No.: US 2026/0170398 A1
(43) Pub. Date: Jun. 18, 2026

(54) ARTIFICIAL INTELLIGENCE (AI) SYSTEM FOR OPTIMAL LOG ACTIVATION

(71) Applicant: INTERNATIONAL BUSINESS MACHINES CORPORATION, ARMONK, NY (US)

(72) Inventors: Brian P. Carey, Raleigh, NC (US); Soumitra Sarkar, Cary, NC (US); Roger L. Bales, Cary, NC (US); Suhas Venkatesh Kashyap, Apex, NC (US)

(21) Appl. No.: 18/979,820

(22) Filed: Dec. 13, 2024

(51) Int. Cl. G06N 20/00; A63F 13/69; A63F 13/77

(52) U.S. Cl. CPC G06N 20/00; A63F 13/69; A63F 13/77

(57) ABSTRACT

Systems and methods are provided for activating logs using game play. A plurality of solved historical records and a plurality of trigger event rules are input to build a reinforcement learning (RL) environment. For each of the plurality of historical records, identify each occurrence of a message entry sequence where any trigger event rule is first found in the historical record and is preceded by different log message entry. A plurality of percents is created, one for each identified occurrence of the message entry sequence. The created RL simulation environment comprises: the plurality of solved historical records, the plurality of trigger event rules; a count of all the plurality of solved historical records; and the plurality of percents. The RL model is trained using the RL simulation environment. The training generates a reward, and the training continues until no improvement is measured. The trained RL model is deployed and activated.

### BACKGROUND

This invention relates generally to computer systems, and more particularly to optimal log activation rules for root cause analysis for problem determination using artificial intelligence (AI).

Generally, when software modules fail, only the minimal default set of logs is enabled. This can be due to several factors. For example, if this is the first occurrence, it is unlikely that a root cause analysis is successful based solely on the default logs. Therefore, some level of expert analysis is needed to plan which additional logs should be enabled to capture sufficient problem determination information to resolve the failure upon its next occurrence. This cycle of software failure, log analysis, and additional log activation is likely to be repeated several times until the software failure is ultimately diagnosed and resolved. In the meantime, each occurrence has a negative impact to the customer's business.

It would be advantageous to provide a system to intelligently activate additional levels of logging when a software failure is detected as being imminent in currently active logs.

### SUMMARY

Systems and methods are provided for activating logs using game play. A plurality of solved historical records and a plurality of trigger event rules are input to build a reinforcement learning (RL) environment. For each of the plurality of historical records, identify each occurrence of a message entry sequence where any candidate activation rule is first found in the historical record and is preceded by different log message entry. A plurality of percentages is created, one for each identified occurrence of the message entry sequence. The created RL simulation environment comprises: the plurality of solved historical records, the plurality of candidate activation rules; a count of all the plurality of solved historical records; and the plurality of percentages. The RL model is trained using the RL simulation environment. The training generates a reward, and the training continues until no improvement is measured. The trained RL model is deployed and activated.

### BRIEF DESCRIPTION OF THE SEVERAL VIEWS OF THE DRAWINGS

Embodiments are further directed to computer systems and computer program products having substantially the same features as the above-described computer-implemented method.

FIGS. 1-2 illustrate flow charts for performing offline data analysis in preparation for building a simulation environment;

FIGS. 3A and 3B illustrate offline processing for identifying rule candidates;

FIG. 4 illustrates a flow chart for training the RL model using the simulation environment;

FIG. 5 illustrates a flow chart for deploying and operation of the trained RL model; and

FIG. 6 illustrates the operating environment of a computer server embodying a system for optimal log activation.

### DETAILED DESCRIPTION OF THE INVENTION

Software products, from operating systems to applications, generally include various logging options, for example error code capture and function tracing, to provide support teams with sufficient problem determination information to hopefully successfully complete root cause analysis on a first failure occurrence.

However, it is not unusual for only the default set of logs for each software product to be enabled. One reason is that unless the customer is already experiencing intermittent symptoms, especially common in performance and network issues, there is little incentive to expect additional logging will be needed. Additionally, logging, especially at the more detailed levels, is expensive in disk space, CPU, and network resources to generate and store the output. Some level of expert analysis is needed to plan which additional logs should be activated to capture sufficient problem determination information to resolve the failure upon its next occurrence, and such analysis is subject to error. This cycle of software failure, log analysis, and additional log activation is likely to be repeated several times until the software failure is ultimately diagnosed and resolved. Once a complex failure occurs, in software or hardware, it is usually quite difficult to be able to recreate it under the exact same initial conditions when the original fault occurred. Therefore, it is all the more critical that optimal log activation rules be learned from successfully resolve past cases, instead of trying to learn them from a currently reported case and asking the customer to recreate the problem with more logs turned on. In practice, such ‘recreates’ are quite difficult to achieve, especially for nontrivial problems and failures.

In the meantime, each occurrence negatively impacts the customer's business. It would be advantageous to intelligently activate additional levels of logging when an imminent software failure is detected. However, to effectively gather documentation for problem determination, the correct logs must be activated in the correct sequence, typically within milliseconds as soon as pertinent messages are written to the currently activated logs. Since this must optimally be done at processor speed, this log activation is beyond the capability of the human mind.

When contacting a software product vendor to open a new incident record, a customer submits any collected logs, error messages, failure symptoms, recreation procedures, or similar diagnostic data. In current practice without embodiments of the present invention, a customer service professional searches the repository of historical incident records, using keyword searching by error code, string searching for error messages, or some similar manual process to attempt to locate a similar incident record that may resolve the customer's problem. There may easily be hundreds of thousands of historical incident records to analyze manually, and the accuracy of the search may depend on whether the correct diagnostic data was collected, the skill of the current customer service professional in crafting the search, the skill of the customer service professional who resolved a past case, and how well organized the incident records are.

Embodiments of the present invention provide an automated policy based on risk to deploy an artificial intelligence (AI) model that is trained using reinforcement learning (RL). The system for optimal log activation treats the problem of activating the required logs in a just-in-time fashion as a game. A win occurs when all the required logs are activated by time the customer opens a customer incident record (record). A loss occurs if further problem determination, such as log data, is needed when the customer opens the incident record and root cause analysis of the customer problem cannot be effectively performed with the log data available when the case was opened. Learning the rules of the game is best achieved using RL rather than supervised/unsupervised machine learning (ML) because, briefly, for example, ML is trained using labeled data (supervised) or unlabeled (unsupervised) data to classify data or to identify clusters (or groupings) of data. In contrast, in RL an autonomous agent learns how to make decisions by interacting with a simulation environment and learning the rules, as in a game, and being rewarded (winning) or penalized (losing) based on actions taken. Once trained in the simulation environment, an RL model can interact with a real environment and take actions to keep on winning. Examples of RL models deployed currently are game playing programs such as AlphaGo or the core AI software component of any self-driving car, where the game is won if the driver using the self-driving car arrives at the destination safely with no accidents.

The RL simulation environment for the domain, in this case log activation, is essential for training the RL model, and must be built offline before it is used for training the RL model. The simulation environment is built using a combination of a defined set of trigger events per type of log where such an event can occur as defined by the domain subject matter experts, the repository of solved historical incident records (historical records) that a software product vendor maintains often as an aid in resolving open incidents, and all log files that were submitted by the user in association with a single case or incident record in order to help solve the problem/incident which was reported. Only historical records which were successfully resolved and had all necessary logs available, ideally when the case was originally opened, are used to construct the RL model simulation environment.

These historical records may be used for other purposes, such as trend analysis to identify areas of a software product that would benefit from modernization (new features), or quality improvement (high failure rate or poor performance).

One or more subject matter experts (SME) provide the initial set of trigger events as input to the RL simulation, typically based on their expertise and experience. Defining the set of trigger events is likely a manual process initially. Table 1 shows a non-limiting example of possible trigger events. In the example, Table I reflects possible trigger events for IBM© IMS™ (IBM and IMS are trademarks or registered trademarks of International Business Machines Corporation in the United States and/or other countries). Note that each of these are only the preconditions, which if observed by the trained RL model would trigger the activation of a new log. Other trigger events can be defined for other products, depending on the software vendor's requirements. The important factor toward success is that the trigger events reflect the necessary conditions to activate new logs.

TABLE I

anyPriorDoc contains performance error
anyPriorDoc contains a log archiving message
anyPriorDoc contains an operating system message
SYSLOG contains a recovery key

The software product vendor defines the format of the historical record. This is a support record of an incident (i.e., case, or ticket, incident record). The logs that are associated with the incident record may be entities that are separate from the incident record but linked to the incident record. The fields included in the incident record depends on the data required for problem identification and resolution. Minimally the data includes a record identifier, dates and timestamps, error codes and messages, a product identifier, codes indicating actions taken toward resolving the record, a resolution code, log identifiers corresponding to the software product that created the record, and any links that associate the logs to the incident record. Additionally, each log submitted with the record may be flagged to indicate whether or not the log was useful. Alternatively, this flag may be programmatically added to the record in preparation for using the record for building the RL simulation environment and training the RL model.

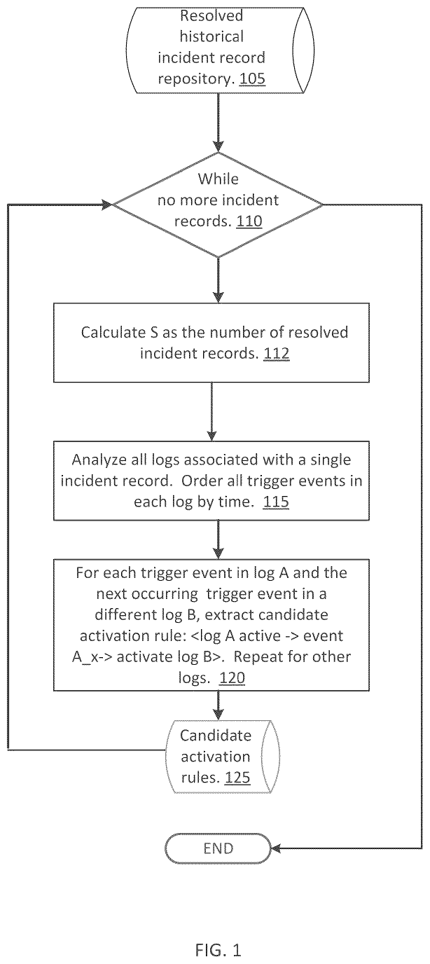

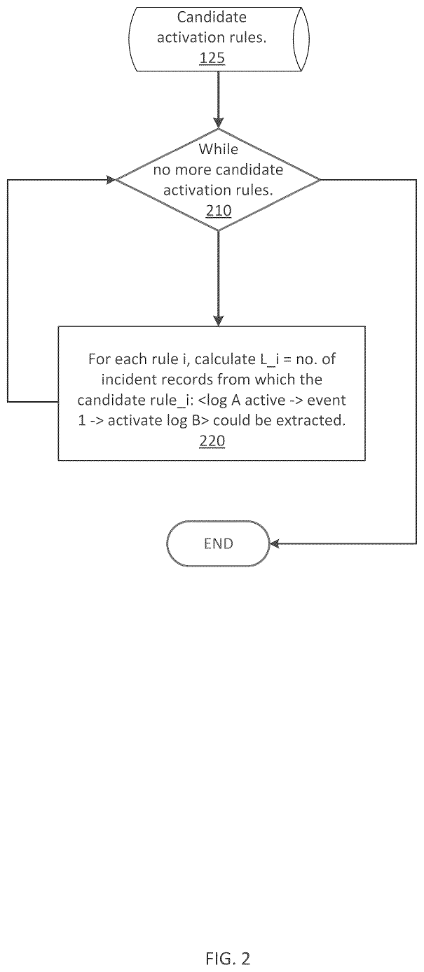

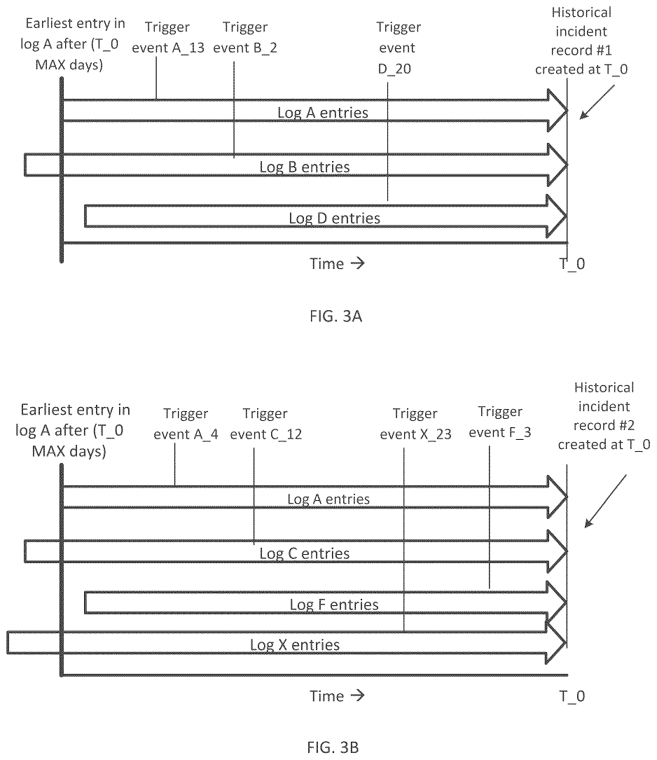

FIG. 1 illustrates the first portion of performing offline data analysis, using a repository of solved historical incident records 105 for outputting and storing the activation rules. As part of the offline analysis to prepare the simulation environment to train the RL model, a count S of the number of resolved incident records is computed. For each resolved historical incident records in the repository (110), offline analysis processes all the log records that are associated with that incident record (112, 115). In this context, a solved historical incident record is one that had all the necessary logs available and was resolved successfully. A max number of days may be configured, whereby the program 750 will not consider log entries older than the configured max. In each log, identify trigger events that are pre-defined by the SMEs for that type of log. It may be the case that the logs and trigger events span more than one product and may include trigger events from the operating system. The program 750 orders the identified trigger events for an incident by time, using for example a timestamp in the log record that contains the identified trigger event. For each trigger event in, for example log A, and the next occurring trigger event in a different log B, the program 750 extracts a candidate activation (rule_i) (120). This is repeated for each log, and described with reference to FIGS. 3A-3B. All the identified candidate activation rules are stored in a repository 125 for input to FIG. 2.

In FIG. 2, for each candidate activation in the candidate activation rules 125 (210), the program (750) calculates L_i, as the number of incident records from which the candidate activation rule can be extracted. There is a separate count L_i of the number of historical incident records from (the logs of) which the specific candidate activation rule could be extracted. The processes of FIGS. 1 and 2 can also be performed by one or more separate programs, for example by a string search matching the list of trigger events against the log.

At 220, once all the candidate activation rules of the form <log A active→event 4 activate log B>are extracted from all historical incident records that were successfully resolved with all required logs, calculate the following metric per candidate activation rule:
L_i=number of incident records from which the candidate activation rule_i: <log A active→event→activate log B>could be extracted.

In the FIG. 3A example, Trigger event A_13 is found in Log A, Trigger event B_2 is found in Log B, and Trigger event D_20 is located in Log D. Assume that time T_0 is the timestamp when the historical incident record is opened. Order trigger events in all logs for the incident by time that are newer than a configurable max number of days. For each trigger event in a log, log A, and the next occurring trigger event in a different log, log B, the candidate activation to extract is <log A active→event→activate log B>. Log B being active may prompt logging another trigger event. In this manner, a candidate activation rule i is extracted from the logs associated with the incident record, and later used by the RL simulation environment to reward the RL model for an action during training.

In FIG. 3A, for historical incident record #1, the extracted candidate activation rules are:
<Log A active→event A_13→activate Log B>
<Log B active→event B_2→activate Log D>

Note that trigger event D_20 does not yield a potential candidate activation rule since no other log was active for this case.

Applying the discussion of FIG. 3A to FIG. 3B, the candidate activation rules are:
<Log A active→event A_4→activate Log C>
<Log C active→event C_12→activate Log X>
<Log X active→event X_23→activate Log F>

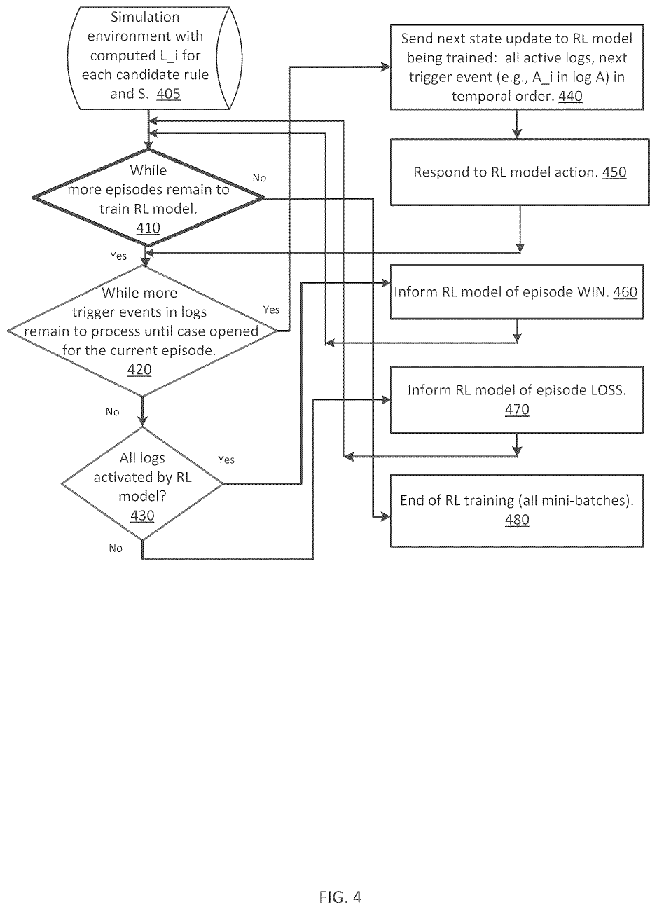

Note that trigger even F_3 does not yield a potential candidate activation rule since no other log was active for this case. FIG. 4 illustrates a flow chart for training the RL model using as input the simulation environment created in FIGS. 1-2 (405). The metrics L_i and S are stored in the simulation environment constructed for training the RL model. For training the RL model for game-playing, each episode corresponds to a historical solved incident record, i.e., a won game, comprising a series of steps. At 410 each episode is input for training the RL model. Each episode may be considered a model training minibatch if a deep learning RL model is used. If at 410 there are no more episodes, then at 480 RL model training ends.

If at 420 there are no more trigger events in the logs remaining to process before the time the incident was opened, processing continues to 430. If at 420, there are more trigger events in the remaining logs, then the simulation environment sends the next state update to the RL model being trained (440). The state comprises all active logs, and the next trigger event (e.g., A_i in log A) in temporal order. At 450 the simulation environment responds to the RL model action: activate log B with reward=L_i/S for matching a rule. If there is no matching candidate for the RL model action, the reward=0.0. Processing returns to 420.

If at 430 the RL model activates all logs, then the RL model learns it has won the episode (460). Processing continues at 410 for the next episode. If at 430 all logs are not activated by the RL model prior to the time the incident is opened, then at 470 the simulation environment informs the RL model of the episode loss, and processing continues at 410.

If at 420, there are no more trigger events in the remaining logs, then the simulation environment sends the next state update to the RL model being trained (440). The state is all active logs, the next trigger event (e.g., A_i in log A) in temporal order. At 450 the simulation environment responds to the RL model action: activate log B with reward=L_i/S for matching a rule. If there is no matching candidate for the RL model action, the reward=0.0. Processing returns to 420.

Note that depending on the type of RL model being trained prior to deployment, traditional or deep learning based, model parameter updates as a key component of the learning process may be performed during or after each episode—as is standard (prior art) practice in the theory and practice Reinforcement Learning.

Once deployed, the RL model can be retrained if it is observed that the operational model is losing accuracy over time.

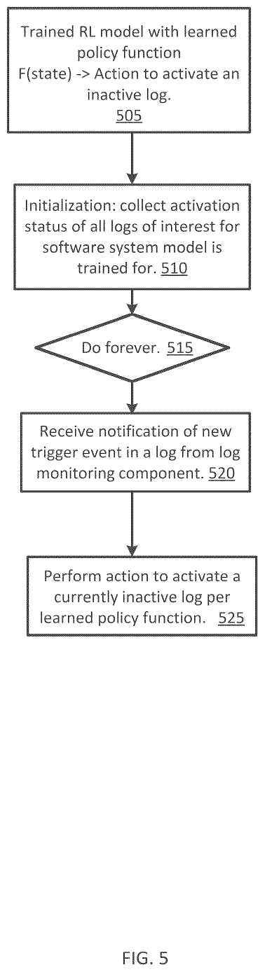

FIG. 5 illustrates a flow chart for deploying and operation of the trained RL model. At 505 the trained RL model is deployed with learned policy function F(state)->action to activate an inactive log. At 510 the deployed RL model is initialized. The deployed RL model collects the activation status of all logs of interest for the system the model is trained for. Until the RL model is deactivated (515), the RL model receives a notification of a new trigger event in a log from the system's log monitoring component (520). At 530, the RL model performs the action to activate a currently inactive log according to the policy function the RL model learned during training in the simulation environment (525). Any active log could be deactivated manually or by the AI system, if no trigger event has been observed in the log for a pre-configured time, such as minutes or hours.

Once deployed, the RL model can be retrained if it is observed that the operational model is losing accuracy over time.

In summary, for training the RL model for game-playing, each episode corresponds to a solved record, i.e., a won game, comprising a series of steps. The RL simulation environment for training includes the historical annotated records, and the trigger events—utilized to learn an RL policy function. The observed state is the current activated logs. An action corresponds to activating a log that is currently not active, or taking no action, depending on the policy. During training, the reward is generated per action as: f(log A, event 1)=activate log B, reward=L_i/S. The episode continues during RL model training until the RL model activates all needed logs before the time the case was opened, i.e., win, or the case was opened without all needed log turned on i.e., a loss. The training continues on all episodes until no improvement is measured.

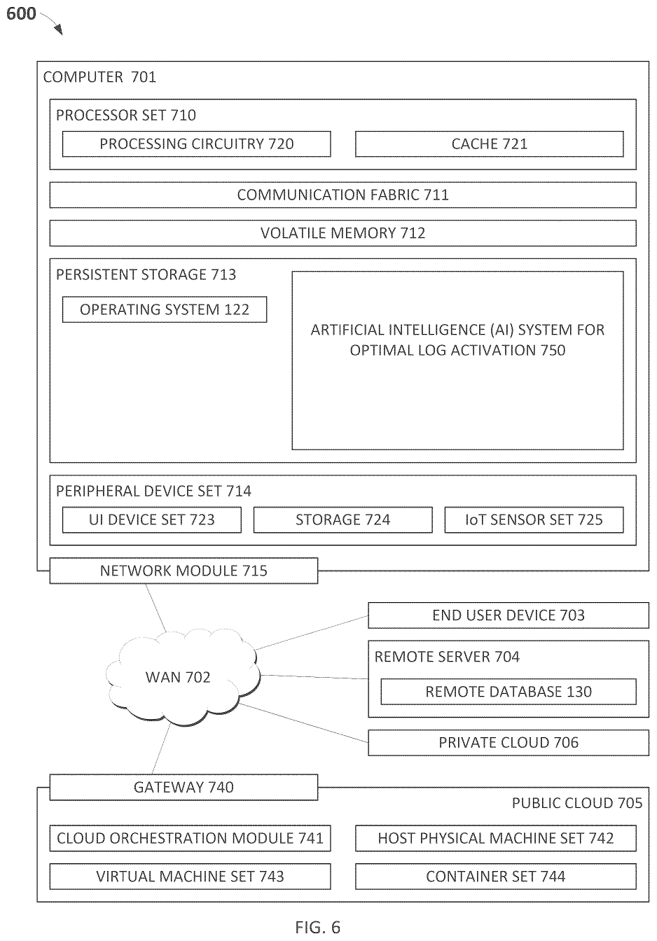

Turning now to FIG. 6, an illustration of the operating environment of a networked computer is presented, according to an embodiment of the present invention.

Computing environment 600 contains an example of an environment for the execution of at least some of the computer code involved in performing the inventive methods, such as artificial intelligence (AI) system for optimal log activation 750 (RL model). The RL model 750 includes offline processing of historical incident records and logs, preparation of the simulation environment to train the RL model, and the trained RL model itself which is deployed. In addition to block 750, computing environment 600 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 771, volatile memory 712, persistent storage 713 (including operating system 722 and block 750, as identified above), peripheral device set 714 (including user interface (UI), device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 701, to keep the presentation as simple as possible. Computer 701 may be located in a cloud, even though it is not shown in a cloud in FIG. 6. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 600, at least some of the instructions for performing the inventive methods may be stored in block 750 in persistent storage 713.

COMMUNICATION FABRIC 711 is the signal conduction paths that allow the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, the volatile memory is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid-state storage devices. Operating system 722 may take several forms, such as various known proprietary operating systems or open-source Portable Operating System Interface type operating systems that employ a kernel. The code included in block 750 typically includes at least some of the computer code involved in performing the inventive methods.

PERIPHERAL DEVICE SET 114 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 115.

WAN 702 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, an administrator that operates computer (701), and may take any of the forms discussed above in connection with computer 701. For example, EUD 703 can be the external application by which an end user connects to the control node through WAN 702. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

As may be used herein, the terms “substantially” and “approximately” provide an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to.” As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with,” includes direct and/or indirect coupling of separate items and/or one item being embedded within another item.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules, and components herein, can be implemented as illustrated or by discrete components, application specific integrated circuits, processors executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from Figure to Figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information. A computer readable memory/storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method of activating logs using game play, comprising:
receiving a plurality of solved historical records and a plurality of trigger event rules;
for each of the plurality of solved historical records, identifying each occurrence of a message entry sequence where any trigger event rule is first found in the historical record and is preceded by different log message entry;
creating a plurality of percentages, one for each identified occurrence of the message entry sequence;
creating a reinforcement learning (RL) simulation environment comprising: the plurality of solved historical records, the plurality of trigger event rules; a count of all the plurality of solved historical records; and the plurality of percents;
training an RL model using the RL simulation environment, wherein the training generates a reward, and wherein the training continues until no improvement is measured; and
based on the RL model being trained, deploy and activate the RL model.

2. The method of claim 1, wherein during training each action corresponds to correctly executing the candidate activation event rule.

3. The method of claim 1, wherein during training the reward is generated per each action as f(log A, event 1)=activate log B, reward=L_i/S.

4. The method of claim 1, wherein the training continues until the RL model activates all logs needed to solve an episode before a time of the historical record being opened, and wherein the episode comprises a set of log activation steps in time during the processing of one of the plurality of solved historical records.

5. The method of claim 1, wherein each of the plurality of historical records includes an indicator of utility of a log in resolving a solved historical record.

6. The method of claim 1, wherein the RL model during training activating all logs needed to solve an episode according to the trigger event rule before a time of the historical record being opened is a game win.

7. The method of claim 1, wherein a game loss comprises the RL model during training not activating all logs needed to perform problem determination before an incident report is opened.

8. A computer program product for activating logs using game play, the computer program product comprising a non-transitory tangible storage device having program code embodied therewith, the program code executable by a processor of a computer to perform a method, the method comprising:
receiving a plurality of solved historical records and a plurality of trigger event rules;
for each of the plurality of solved historical records, identifying each occurrence of a message entry sequence where any trigger event rule is first found in the historical record and is preceded by different log message entry;
creating a plurality of percents, one for each identified occurrence of the message entry sequence;
creating a reinforcement learning (RL) simulation environment comprising: the plurality of solved historical records, the plurality of trigger event rules; a count of all the plurality of solved historical records; and the plurality of percents;
training an RL model using the RL simulation environment, wherein the training generates a reward, and wherein the training continues until no improvement is measured; and
based on the RL model being trained, deploy and activate the RL model.

9. The computer program product of claim 8, wherein during training each action corresponds to correctly executing the trigger event rule.

10. The computer program product of claim 8, wherein during training the reward is generated per each action as f(log A, event 1)=activate log B, reward=L/S.

11. The computer program product of claim 8, wherein the training continues until the RL model activates all logs needed to solve an episode before a time of the historical record being opened, and wherein the episode comprises a set of steps in time during one of the plurality of solved historical records.

12. The computer program product of claim 8, wherein each of the plurality of historical records includes an indicator of utility in a log in resolving a solved historical record.

13. The computer program product of claim 8, wherein the RL model activating all logs needed to solve an episode according to the trigger event rule before a time of the historical record being opened is a game win.

14. The computer program product of claim 8, wherein a game loss comprises the RL model not activating all logs needed to perform problem determination before an incident report is opened.

15. A computer system for activating logs using game play, the computer system comprising:
one or more processors;
a memory coupled to at least one of the processors;
a set of computer program instructions stored in the memory and executed by at least one of the processors in order to perform actions of:
receiving a plurality of solved historical records and a plurality of trigger event rules;
for each of the plurality of solved historical records, identifying each occurrence of a message entry sequence where any trigger event rule is first found in the historical record and is preceded by different log message entry;
creating a plurality of percents, one for each identified occurrence of the message entry sequence;
creating a reinforcement learning (RL) simulation environment comprising: the plurality of solved historical records, the plurality of trigger event rules; a count of all the plurality of solved historical records; and the plurality of percents;
training an RL model using the RL simulation environment, wherein the training generates a reward, and wherein the training continues until no improvement is measured; and
based on the RL model being trained, deploy and activate the RL model.

16. The computer system of claim 15, wherein during training each action corresponds to correctly executing the trigger event rule.

17. The computer system of claim 15, wherein during training the reward is generated per each action as f(log A, event 1)=activate log B, reward=L/S.

18. The computer system of claim 15, wherein the training continues until the RL model activates all logs needed to solve an episode before a time of the historical record being opened, and wherein the episode comprises a set of steps in time during one of the plurality of solved historical records.

19. The computer system of claim 15, wherein each of the plurality of historical records includes an indicator of utility in a log in resolving a solved historical record.

20. The computer system of claim 15, wherein the RL model activating all logs needed to solve an episode according to the trigger event rule before a time of the historical record being opened is a game win; and
a game loss comprises the RL model not to activating all logs needed to perform problem determination before an incident report is opened.
